(19) United States
(12) Patent Application Publication
(10) Pub. No.: US 2013/0124531 A1
(43) Pub. Date: May 16, 2013

(54) SYSTEMS FOR EXTRACTING RELEVANT AND FREQUENT KEY WORDS FROM TEXTS AND THEIR PRESENTATION IN AN AUTO-COMPLETE FUNCTION OF A SEARCH SERVICE

(71) Applicant: Walter Bachtiger, Novato, CA (US)

(72) Inventor: Walter Bachtiger, Novato, CA (US)

(21) Appl. No.: 13/735,186

(22) Filed: Jan. 7, 2013

Related U.S. Application Data
(63) Continuation-in-part of application No. 12/878,014, filed on Sep. 8, 2010.
(60) Provisional application No. 61/583,833, filed on Jan. 6, 2012.

(51) Int. Cl. G06F 17/30

(52) U.S. Cl. CPC G06F 17/30091
USPC 707/741

(57) ABSTRACT

Systems for searching and reviewing text files among a plurality of users are disclosed. The systems include a server that is configured to receive, index, and store a plurality of text files, which are received by the server from a plurality of sources, within at least one database in communication with the server. In addition, the server is configured to provide users with the ability to search for certain text files stored within the system. The search functionality will include an auto-complete feature, which provides a user of the system with a list of proposed key words to use when conducting the search. The proposed key words will represent the most frequently searched and information-rich key words that the system identifies over a period of time.

### CROSS-REFERENCE TO RELATED APPLICATIONS

This application claims priority to, and incorporates by reference, U.S. provisional patent application Ser. No. 61/583,833, filed on Jan. 6, 2012, and is also a continuation-in-part application of U.S. patent application Ser. No. 12/878,014, filed on Sep. 8, 2010.

### FIELD OF THE INVENTION

The field of the present invention relates to systems and methods for searching text files for the presence of key words, and particularly to systems and methods that facilitate the identification of relevant key words for conducting such searches.

### BACKGROUND OF THE INVENTION

Various types of systems and methods exist today, which can be used to search a body of text files for the presence of one or more search terms (key words). However, such currently-available systems and methods do not provide an efficient and effective means for assisting users in the identification and selection of relevant key words for searching such text files.

As described further below, the present invention addresses such drawbacks, and others, which are associated with currently-available systems. More particularly, the present invention enables searchers of text files to quickly identify the most important and relevant search terms to use, based on the content of a large body of text files provided to a system. More particularly, as the following will demonstrate, the present invention provides a novel and extremely beneficial way to identify interesting and relevant search terms (key words) for files (and sets of files), which can be displayed in an auto-complete menu that is connected to a search function, as described and illustrated below.

### SUMMARY OF THE INVENTION

According to certain aspects of the present invention, systems are provided that are configured to provide a means within a graphical user interface of a website to search a plurality of text files for the presence of one or more key words. More particularly, the systems of the present invention comprise one or more servers, which are configured to provide a means for automatically identifying the most relevant, and/or the most frequently searched, key words that a user may select for a particular search. The invention provides that the website may comprise, for example, drop-down menus, search windows, and other areas of the website that will automatically present to a user a plurality of proposed key words to use in a search of numerous text files stored within (or accessible by) the system, with the proposed key words representing the most relevant, and/or the most frequently searched, key words that the system identifies from an aggregated amount of text files that the server receives and analyzes over time.

The above-mentioned and additional features of the present invention are further illustrated in the Detailed Description contained herein.

### BRIEF DESCRIPTION OF THE FIGURES

FIG. 1 is a diagram showing the different components of the systems described herein.

FIG. 2 is a diagram showing the means by which various text files may be searched using the present invention.

FIG. 3 is a diagram showing certain non-limiting components of an exemplary graphical user interface in which a user may query the content of a plurality of text files, identify those text files which include a certain key word (or set of key words) that the user defines (and which may be proposed by the server as described herein), and quickly view the context in which such key word is used in one or more text files.

### DETAILED DESCRIPTION OF THE INVENTION

The following will describe, in detail, several preferred embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

According to certain preferred embodiments, the present invention generally encompasses systems and methods for searching a plurality of text files and, particularly, to systems and methods that facilitate the identification of relevant key words for conducting such searches. The following description will be divided into three parts. A first part of the following description will briefly describe a system that is used to receive, index, and store a plurality of text files, which are received by a server from a plurality of sources, within at least one database in communication with the server. The second part of the description will describe the systems and methods of the present invention, which are capable of searching the indexed and stored content within the server/database. More particularly, the second part will describe the systems and methods that are configured to automatically identify the most relevant, and/or the most frequently-searched, key words that a user may select for a particular search. The third part of the following description will describe certain system functionality, and graphical user interfaces, which are used to review, select, and utilize the content that the system identifies from a search of a plurality of text files.

Text File Indexing and Storage System

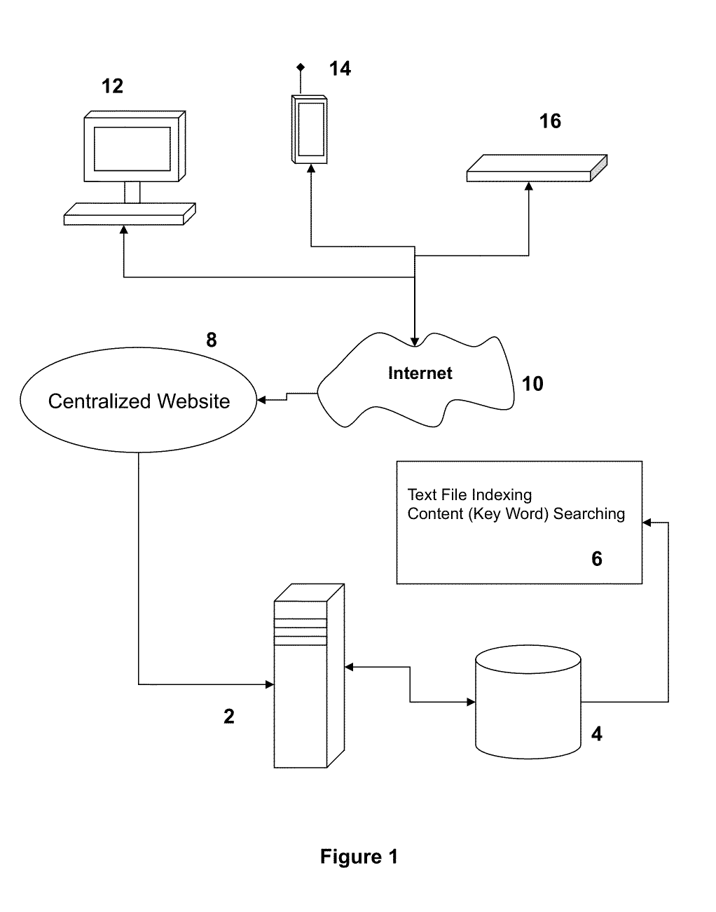

The present invention generally involves the use of systems that are capable of indexing, storing, and making text files available to a plurality of users. Referring to FIG. 1, the systems generally comprise a server 2 that is configured to receive, index, and store a plurality of text files, which are received by the server 2 from a plurality of sources, within at least one database 4 in communication with the server 2. The invention provides that the database 4 may reside within the server 2 or, alternatively, may exist outside of the server 4 while being in communication therewith via a network connection.

The text files may be indexed 6 and categorized within the database 4 based on author, time of recordation, geographical location of origin, IP addresses, language, key word usage, combinations of the foregoing, and other factors. The invention provides that the text files are preferably submitted to the server 2 through a centralized website 8 that may be accessed through a standard internet connection 10. The invention provides that the website 8 may be accessed, and the text files submitted to the server 2, using any device that is capable of establishing an internet connection 10, such as using a personal computer 12 (including tablet computers 16), telephones 14 (including smart phones, PDAs, and other similar devices), and other devices. The invention provides that the text files may be created by such devices and then uploaded to the server 2.

The invention provides that the text files stored within the system may, but will not always, represent text that is generated from a transcription of a media file, such as an audio file or video file that includes audio content. For example, as described further below, the invention provides that upon a media file being submitted to the server 2, the server 2 will perform a speech-to-text, speech-to-phoneme, speech-to-syllable, and/or speech-to-subword conversion, and then store an output of such conversion (in the form of a text file) within the database 4. This way, the content of each media file may be intelligently queried and used in the manner described herein, such as for querying such content for key words.

When the present specification refers to the server 2, the invention provides that the server 2 may comprise a single server or a group of servers. In addition, the invention provides that the system may employ the use of cloud computing, whereby the server paradigm that is utilized to support the system of the present invention is scalable and may involve the use of different servers (and a variable number of servers) at any given time, depending on the number of individuals who are utilizing the system at different time points, which are in fluid communication with the database 4 described herein.

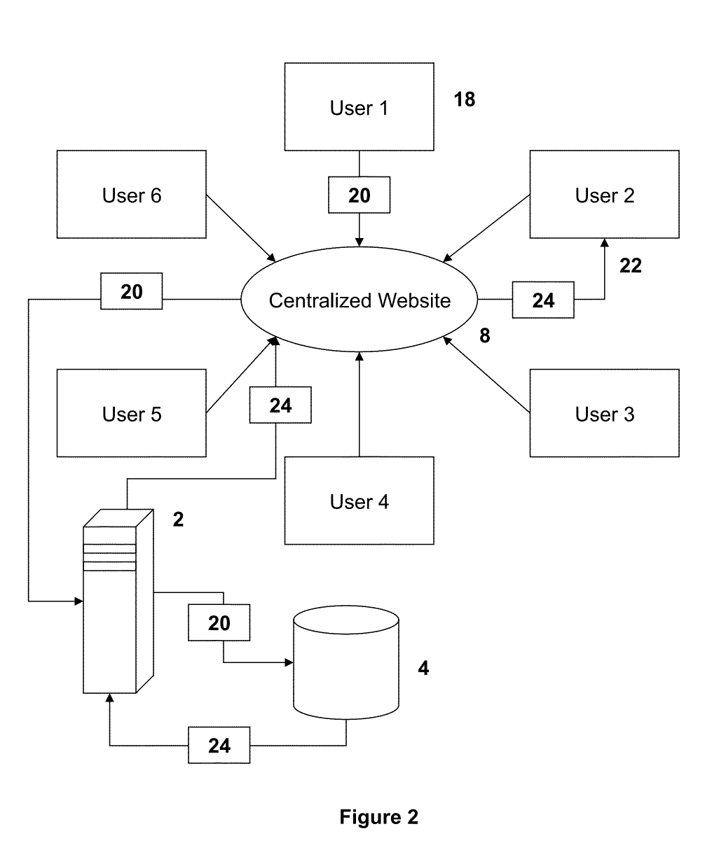

According to certain preferred embodiments, the invention provides that the server 2 is configured to make one or more of the text files accessible to persons other than the original source (or author) of the text files. The invention provides that the term “source” refers to a person who is responsible for uploading a text file to the server 2, whereas the term “author” refers to one or more persons who contributed content to an uploaded text file (who may, or may not, be the same person who uploads the text file to the server 2). For example, referring now to FIG. 2, a first user (User-1) 18 may submit 20 a text file to the server 2 through the centralized website 8, which is then indexed and stored within a database 4. The invention provides that the text files that the first user (User-1) 18 records within and uploads to the database 4 will then be accessible and searchable by other persons. For example, a second user (User-2) 22 may search for, retrieve, and review 24 User-1's text file through the centralized website 8.

Key Word Search Functionality

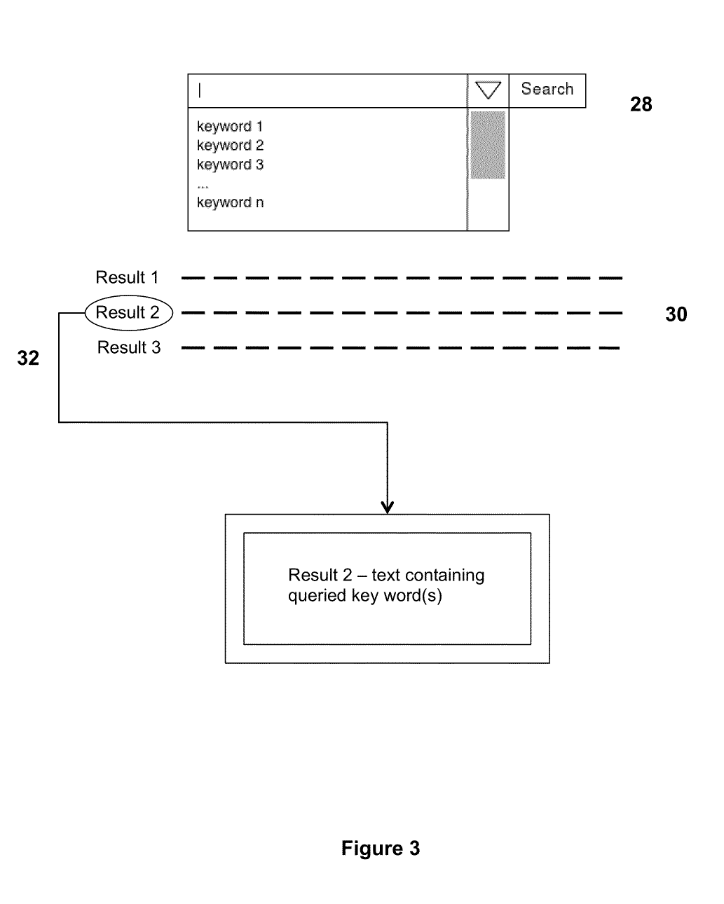

Referring now to FIG. 3, the invention provides that a user of the system may perform a search 28 of the database 4 for desired text files, namely, text files containing one or more search terms (key words), as described herein. The invention provides that the system, and search function 28, may employ Boolean search logic, e.g., by allowing conjunctive and disjunctive searches, truncated and non-truncated forms of key words, exact match searches, and other forms of Boolean search logic.

According to certain preferred embodiments of the invention, the search functionality 28 may employ an auto-complete feature. For example, the search functionality 28 may utilize an auto-complete drop-down menu, which lists various proposed key words that may be used to perform the search. The invention provides that these proposed key words will preferably represent the most relevant key words, as determined by the server 2 of the system. The server 2 of the system will maintain a running log of the most relevant key words, which will be identified and extracted from text that has been indexed within the system as described above. In certain embodiments, the server 2 may also maintain a list of automatically extracted key words for each text file that is submitted to the system, which can be augmented by an administrator/manager of a particular text file, with the running list of relevant key words being computed by aggregating such key word lists.

In certain embodiments, the search functionality 28 may also be configured to automatically present a list of proposed key words when a user clicks a search bar (or places a cursor in a search text field). When and if a user selects any of the proposed key words that are presented in the auto-complete feature described above, the system will automatically conduct a search of the plurality of text files stored within the system (server 2/database 4) using the selected key words.

The system will preferably employ an algorithm (or other means) for proposing in the auto-complete feature: (i) the most frequently searched key words, (ii) the key words that are most frequently present in a single text file (or a group of text files), and (iii) the most information-rich key words. In other words, the system will preferably factor all of those criteria when calculating its proposed list of key words, which will thereby create a list of proposed key words that are most relevant to a user of the system. The system will maintain a record of the key words that are most frequently search by users of the system—and a record of how frequently certain key words are present in a single media file (or group of media files).

The system will continually analyze the text that is provided to the system, as the files are being indexed therein. In addition, the system will be configured to analyze the text from all text files that are present in a set of search results generated by users over a period of time. This way, the above-referenced algorithm will be capable of assigning a score to various words (potential key words) included within such bodies of text. This scoring technique may also be applied to adjacent word pairs, or longer sequences of words (e.g., phrases and the like). The criteria that are factored into such scores may include, but are not limited to, the frequency of such key words in a body of text, the length of text in which the key words are present, the nature or type of speech in which such key words are found (in the case of text that has been transcribed from a media file), whether a particular word is a “stop word,” and others.

The system will maintain a running aggregation of scores for a body of key words (or, as mentioned above, groups of key words), with such aggregation being calculated across multiple bodies of texts derived from the text files provided to the system. The system may prioritize and rank key words by calculating a mean score value for each key word (or groups of key words) across the plurality of text files analyzed. The system may then rank such key words based on the calculated mean score values. The invention provides that the system may prioritize and rank key words by other means as well, provided that the goal of such ranking system is to present to a user of the system a set of proposed key words that are possibly the most relevant to the user, based on the most frequently searched and information-rich key words identified by the system. The auto-complete function described herein allows searchers to modify their search terms based upon the menu of choices presented by the system.

The invention further provides that the system may compile a set of proposed key words based upon a speaker detection feature. More specifically, with respect to text files that were generated from media files (as mentioned above), the system may be configured to correlate certain speakers with certain portions of text (which has been transcribed from audio content). In such embodiments, the identification of relevant key words, and the algorithms used to identify such key words as described above, may be carried out for the portions of text that are correlated with a particular speaker. Such methods may be applied to each distinct speaker that is identified across a body of text files (which have been transcribed from audio content). This way, the system may generate a list of proposed key words, for each and every speaker that the system has identified and analyzed in the above manner. In the auto-complete menu described above, the proposed key words that are correlated with each different speaker may be designated by assigning different colors, numbers, or symbols to each speaker. This way, when the auto-complete menu is presented, a user of the system will be able to visually correlate certain proposed key words with specific speakers.

Search Results

Following the search 28, the invention provides that the server 2 will then generate a list of results 30 (within the centralized website 8), i.e., text files that contain one or more of the queried search terms. The user may then select one or more text files within the viewable search results for review 32. The server 2 may present the search results 30 to the user within the website 8 and, preferably, list all responsive text files in a defined order within such graphical user interface. For example, the search results may list the text files in chronological order based on the date (and time) that each text file was recorded and provided to the database 4. In other embodiments, the text files may be listed in an order that is based on the number of occasions that a key word is used within each text file. Still further, the text files may be listed based on the number of occurrences of key words in metadata associated with the text files, such as titles, description, comments, etc. In addition, the text files may be listed by measuring user activity, such as the number of views of such text files. These criteria, combinations thereof, or other criteria may be employed to list the responsive text files in a manner that will be most relevant to the user. Still further, the invention provides that a user may specify the criteria that should be used to rank (and sort) the search results, with such criteria preferably being selected from a predefined list.

The many aspects and benefits of the invention are apparent from the detailed description, and thus, it is intended for the following claims to cover all such aspects and benefits of the invention which fall within the scope and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. A system for searching and accessing text files, which comprises a server that is configured to:
(a) receive, index, and store a plurality of text files, which are received by the server from a plurality of sources, within at least one database in communication with the server;
(b) make one or more of the text files accessible to persons other than the sources of such text files;
(c) allowing such persons to search the text files for one or more key words, wherein the server displays to such persons a list of proposed key words to employ in such search; and
(d) displaying a set of search results within a graphical user interface of a computing device.

2. The system of claim 1, wherein the list of proposed key words are presented in a drop-down menu of the graphical user interface.

3. The system of claim 1, wherein the list of proposed key words are presented in a text box of the graphical user interface, wherein the text box appears when a cursor is positioned in a search window.

4. The system of claim 1, wherein list of proposed key words is compiled by the system based on a search frequency of each key word, wherein the search frequency represents a number of times that each key word is employed in a search across multiple users of the system over a defined period of time.

5. The system of claim 4, wherein the list of proposed key words is compiled by the system based further on data that are correlated to a probability of each key word producing relevant search results.

6. The system of claim 5, wherein the data that are correlated to a probability of each key word producing relevant search results are calculated based on: (i) a frequency of each key word in a body of text, (ii) a length of text in which each key word is present, (iii) a type of speech in which each key word is found, (iv) whether each key word is a stop word, or (v) combinations of the foregoing.

7. The system of claim 1, wherein the list of proposed key words may comprise a series of distinct single words, phrases of words, or combinations of the foregoing.

8. A system for searching and accessing text files that are derived from media files, which comprises a server that is configured to:
(a) receive, index, and store a plurality of media files, which are received by the server from a plurality of sources, within at least one database in communication with the server;
(b) perform a text transcription of audio content included within the media files;
(c) make one or more of the media files accessible to persons other than the sources of such media files;
(d) allowing such persons to search the media files for one or more key words, wherein the server displays to such persons a list of proposed key words to employ in such search; and
(e) displaying a set of search results within a graphical user interface of a computing device.

9. The system of claim 8, wherein the list of proposed key words are presented in a drop-down menu of the graphical user interface.

10. The system of claim 8, wherein the list of proposed key words are presented in a text box of the graphical user interface, wherein the text box appears when a cursor is positioned in a search window.

11. The system of claim 8, wherein list of proposed key words is compiled by the system based on a search frequency of each key word, wherein the search frequency represents a number of times that each key word is employed in a search across multiple users of the system over a defined period of time.

12. The system of claim 11, wherein the list of proposed key words is compiled by the system based further on data that are correlated to a probability of each key word producing relevant search results.

13. The system of claim 8, wherein the list of proposed key words includes an identifier for each key word, whereby each identifier is correlated with its own speaker of content that was transcribed into text and stored within the server, such that the system is configured to assign proposed key words to each of a plurality of speakers.

14. The system of claim 13, wherein the identifier may exhibit a unique color, number, or symbol, which is assigned to a speaker.

15. A system for searching and accessing text files, which comprises a server that is configured to:
(a) receive, index, and store a plurality of text files, which are received by the server from a plurality of sources, within at least one database in communication with the server;
(b) make one or more of the text files accessible to persons other than the sources of such text files;
(c) allowing such persons to search the text files for one or more key words, wherein the server displays to such persons a list of proposed key words to employ in such search, and wherein the list of proposed key words is compiled by the system based on a mean score value that is calculated across an aggregated number of text files, wherein said score value is based on:
(i) a search frequency of each key word; and
(ii) data that are correlated to a probability of each key word producing relevant search results; and
(d) displaying a set of search results within a graphical user interface of a computing device.
